(19) United States
(12) Patent Application Publication
(10) Pub. No.: US 2019/0246615 A1
(43) Pub. Date: Aug. 15, 2019

(54) FISH HANDLING STAND

(71) Applicant: John GUINEA, Cooktown (AU)

(72) Inventor: John GUINEA, Cooktown (AU)

(21) Appl. No.: 16/270,463

(22) Filed: Feb. 7, 2019

(30) Foreign Application Priority Data
Feb. 8, 2018 (AU) 2018900402

(51) Int. Cl. A01K 97/20; B65D 81/38; A01K 97/18

(52) U.S. Cl. CPC A01K 97/20; A01K 97/18; B65D 81/3813

(57) ABSTRACT

The fish handling stand is mounted to the lid of a cooling box by forming a large aperture in the middle portion of the lid. The fish handling stand includes a large diameter tubular wall having an upper opening, an upper edge, a lower opening, and a lower edge. The tubular wall defines an inner cavity therewithin. The lower edge includes a mounting device for the lid adjacent the periphery of the lid aperture. The upper edge includes generally oppositely formed seats for a pin holder. The seats in the embodiment are U-shaped cut-outs for receiving and seating opposite ends or end portions of the pin holder thereon.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a fish handling stand for handling line caught fish.

### 2. Description of Related Art Including Information Disclosed Under 37 CFR 1.97 and 37 CFR 1.98

Fishing is a very popular hobby and sport. Currently, the process of removing a fish caught in a fishing line involves bringing the fish into the boat, putting it in a kill bucket or on the boat deck whilst the fish is unrestrained, and attempting to remove the hook, bleed the fish and get it on ice. This process is difficult and involves handling the fish throughout the entire process which increases the risk of injuries from hooks, fish spikes, and cuts.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a fish handling stand for mounting to a lid of a cooler box, the cooler box having an aperture sized for a fish to extend therethrough, the fish handling stand comprising:
a tubular wall having an upper edge defining an upper opening, a lower edge defining a lower opening, and an inner cavity,
a mounting means adjacent the lower edge for mounting the tubular wall to extend upwardly from the cooler box lid with the inner cavity aligned with the aperture, and
holding formations formed in the upper edge for seating a fish holding pin thereon.

Preferably, the mounting means comprises flanges for attachment to the lid.

Preferably, the holding formations comprises generally oppositely formed seats.

Preferably, the seats are U-shaped cut-outs in the upper edge.

Preferably, the tubular wall is conical or part conical.

Preferably, the tubular wall is shaped as an inverted funnel or inverted part cone shape.

Preferably, the stand comprises sealing means for sealing the upper opening, the lower opening, or the inner cavity.

Preferably, the sealing means comprise bristles or overlapping flaps extending across the inner cavity.

Preferably, the sealing means is adapted to seal against the fish in the inner cavity in use.

In another embodiment, the sealing means comprises a flexible member having slits formed therein which forms contiguous flaps extending across the inner cavity of the wall to substantially close the lower opening.

Preferably, the upper opening or the lower opening can be made resilient to be normally closed which can then be opened in use.

Preferably, the stand comprises a retaining means for retaining the fish holding pin thereon.

Preferably, the stand comprise a fish holding pin for insertion into a fish gill cavity.

The present invention also provides an assembly comprising a lid for a cooler box and the fish handling stand of the above mounted thereon.

The present invention also provides an assembly comprising a cooler box having a lid, and the fish handling stand of the above mounted thereon

The present invention also provides a method of handling fish using the above assembly, the method comprising:
guiding the fish into the upper opening such that the fish is within the inner cavity,
inserting a fish holding pin through the gill cavity of the fish,
and placing the pin holder onto the holding formations of the upper edge.

The method preferably comprises:
removing the fish hook,
severing the gills of the fish with fin snips, and
pulling the fish holding pin to allow the fish to drop into the cooler box.

In another aspect, the present invention provides a fish handling stand for mounting to a lid of a cooler box, the cooler box having an aperture, the fish handling stand comprising:
opposing stands for mounting to the lid to extend upwardly from the lid, the stands having seats at either side of the aperture for holding ends of a holding pin, the seats being spaced upwardly from the lid.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 is a side view of an assembly comprising a fish handling stand in accordance with a preferred embodiment of the present invention with the fish handling stand mounted to a portable cooler.

FIGS. 2A, 2B, and 2C show a perspective view, an inverted perspective view, and an exploded perspective view, respectively of a fish handling stand in accordance with another preferred embodiment.

### DETAILED DESCRIPTION OF THE INVENTION

It should be noted in the following description that like or the same reference numerals in different embodiments denote the same or similar features.

It should be noted in the following description that like or the same reference numerals in different embodiments denote the same or similar features.

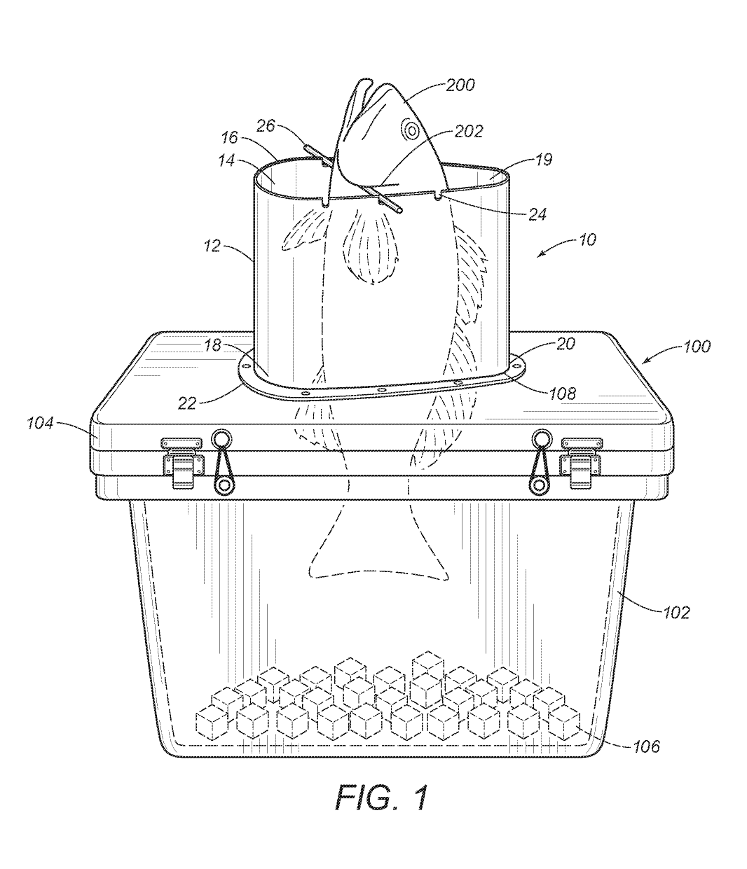

FIG. 1 shows a fish handling stand 10 according to a preferred embodiment mounted to a portable cooler box 100. The cooler box 100 (also called ice chest, cool box, esky, etc.) as is known is an insulated box 102 with a lid 104 and is used to keep food or drinks cool. In fishing applications, the cooler box 100 is typically used to hold ice 106 to keep caught fish (the catch) fresh.

The fish handling stand 10 is designed to be mounted to the lid 104 by forming a large aperture 108 in the middle portion of the lid 104.

The fish handling stand 10 comprises a large diameter tubular wall 12 having an upper opening 14, an upper edge 16, a lower opening 18, and a lower edge 20. The tubular wall 12 defines an inner cavity 19 therewithin. The lower edge 20 comprises mounting means 22 for mounting to the lid 104. In the embodiment, the mounting means comprises flanges 22 for attachment to the lid 104, adjacent the periphery of the lid aperture 108.

The upper edge 16 comprises generally oppositely formed seats 24 for a pin holder 26. The seats 24 in the embodiment are U-shaped cut-outs for receiving and seating opposite ends or end portions of the pin holder 26 thereon.

The upper opening 14 and the lower opening 18 in the example are 30 cm in diameter, or the openings can be oval shaped and having a long diameter of 30 cm. The pin holder 20 is made from stainless steel or a hardened plastic and is longer than the distance between the seats 20, and in the example is about 40 cm long. The fish handling stand can however be made to any desired dimensions.

In use, the aperture 108 is formed in the central portion of the lid 104. The aperture 108 is dimensioned and shaped for mounting of the mounting means 22. The mounting means 22 is then mounted to the lid 104 such that the fish handling stand 10 extends upwardly from the lid 104 as shown in FIG. 1. Ice 106 is held within the cooler 100. The cavity 19 of the fish handling stand 10 is aligned with the aperture 108.

When the user catches a fish 200 using a fishing line, the user uses the fishing line to guide the fish 200 into the upper opening 14 such that the fish 200 is within the inner cavity 19. The fish 200 can partly extend into the cooler box 100 via the aperture 108. The pin holder 26 is then inserted through the gill cavity 202, and the pin holder 26 is placed into the seats 24. This incapacitates and holds the fish 200. This provides the fisherman with two free hands to remove the fish hook or attend to other tasks as needed.

Once the hook is removed, the gills of the fish are severed with fin snips which starts the bleeding process and avoids air entering the gut cavity which causes decomposition (which can happen when the throat is cut on a fish). Once bleeding has commenced, the pin holder 26 is pulled out of the gill cavity 202 which allows the fish 200 to drop directly into the ice 106 within the cooler 100.

The assembly thus provides an insulated cooler for holding ice slurry, with the fish catch going into an ice slurry, which brings the temperature of the fish down rapidly. The fish can bleed into the ice slurry and due to the low temperature, will not spoil the fish.

The fish handling stand allows a fisherman to stop handling the caught fish to prevent spikes, bites, cuts with gills and having slime over their hands. This makes the whole process from catching the fish to putting the fish on ice more user friendly and hands free.

The embodiment allows a user to bring a fish into the boat, restrain it so that the user has two hands free to remove the hook, then bleed the fish, before removing the pin and having the fish drop into an ice slurry, all without having touched the fish. The time of this process is significantly less than the current process of getting a fish to the ice down stage.

Whilst preferred embodiments of the present invention have been described, it will be apparent to skilled persons that modifications can be made to the embodiments described.

For example, the wall of the fish handling stand can be shaped as desired and can be for example an inverted funnel or inverted part cone shape. The upper opening and/or the lower opening of the fish handling stand can be made to include sealing means for sealing or substantially sealing the cold internal compartment of the cooler. Such sealing means can comprise bristles or overlapping flaps or contiguous flaps extending across the cavity of the wall to substantially close the opening but allow insertion of the caught fish therethrough. The sealing means can also be adapted to seal against the caught fish. Alternatively, the upper opening can be made resilient to be normally closed (and thus providing a seal), which can then be opened. The tubular wall can be made from resilient material for example.

In another possible embodiment, the fish handling stand can be made to be formed with a cooler box lid, or formed with the cooler box. The fish handling stand on top of the cooler box will be part of the moulded cooler box lid, and on the underside of the cooler box lid, there will be nylon bristles covering the opening to prevent cold air escaping. In use, the fish will fall through the bristles into the ice slurry, and the bristles will then spring back into place.

The cooler box sealing means can also be a retractable insulation component that stops the cold air from escaping each time a fish is added to the ice slurry. Pockets can be moulded into the wall of the fish handling stand or the wall of the cooler box to accommodate fin snips, gill pin, knife and other tools required. An additional compartment can also be attached to the end of the fish handling stand which will be a multi-purpose insulated compartment for holding an extra block of ice or keep food from getting wet.

The fish handling stand can be provided as a self-assembling kit for mounting to a user's existing cooler box. The speed of the process from catching the fish to having it on ice is significantly enhanced. There is a reduction in the handling of the fish therefore reducing injuries from hooks, spikes, bites, cuts, etc. The fish is bled and on ice much faster, and the quality of the fish is preserved due to fish not jumping around in the kill tank bruising the flesh. The embodiment also eliminates use for a kill tank, and provides a more humane process of killing a fish as the process from catching the fish to getting it on ice is significantly reduced. After lowering the fish into the cone opening, this allows the user to have two hands free to remove the hook without the fish thrashing around the boat. The embodiment will also have a sealing means, such as a retractable or resilient insulation component that stops the cold air from escaping each time a fish is added to the ice slurry.

The invention is a piece of equipment that can be used by anyone (male/female/young/old) fishing. It allows for a more user friendly and hands free approach for the handling of a fish. The fish handling stand is a specialised kit that once fitted to a cooler box, combines a restraining area for the fish, kill bucket and an ice slurry all in one, reducing the number of items on a boat and reducing slime/blood throughout the boat.

The fish handling stand can also be used on its own, for example, over a sink for dealing with live fish at a restaurant. The fish handling stand can additionally include a frame or legs for extending above a surface or sink area.

In another embodiment, the tubular wall can be omitted and the fish handling device can comprise opposing stands for holding ends of the holding pin.

In another embodiment, the holding formations for the holding pin can instead be holes formed in the side wall. The holding seats can also include locking means thereon to retain the holding pin in place.

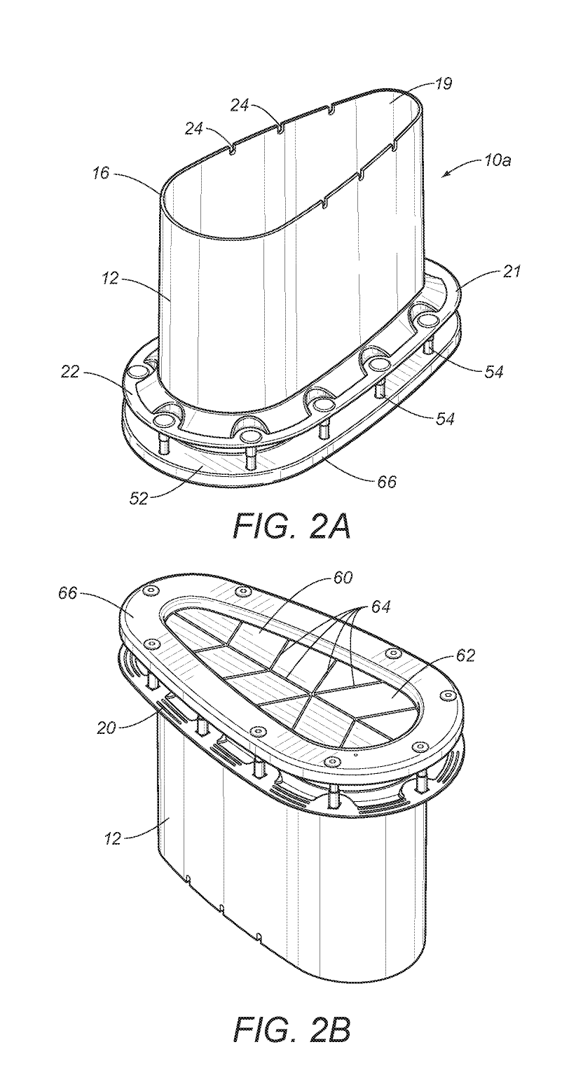

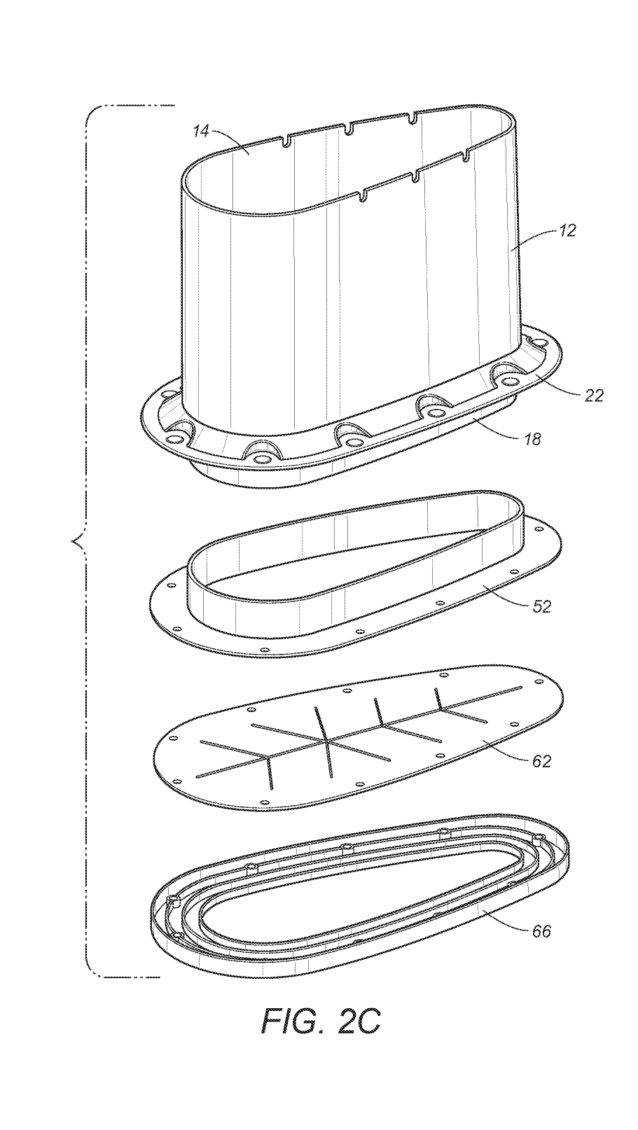

FIGS. 2A, 2B, and 2C show a fish handling stand 10a according to another preferred embodiment for mounting to a portable cooler box 100.

The fish handling stand 10a also comprises a tubular wall 12 having an upper opening 14, an upper edge 16, a lower opening 18, and a lower edge 20. The tubular wall 12 is generally oval shaped and defines an inner cavity 19. One side end of the tubular wall 12 is wider than the opposite side end thereof. The lower edge 20 comprises mounting means 21 for mounting to the lid 104.

In this embodiment, the mounting means comprises a first flange 22 at the lower edge 20 and a ring 50 having a second flange 52. The ring 50 has an outline shape corresponding to the tubular wall 12 and is party received in the lower opening 18 through the aperture 108 in the lid 104. The first flange 22 and second flange 52 are disposed on opposite sides of the lid 104 and are connected by spaced bolts 54 such that the flanges 22 and 52 clamp onto the lid 104 and the tubular wall 12 extends upwardly from the lid 104 to mount the handling stand 10a to the periphery of the lid aperture 108. The bolts 54 can extend through bolt apertures in the lid or can be adjacent the periphery of the lid aperture 108.

The upper edge 16 comprises spaced pairs of oppositely formed seats 24 for the pin holder 26. The seats 24 in the embodiment are U-shaped cut-outs for receiving and seating opposite ends or end portions of the pin holder 26 thereon. The distance between the seats 24 varies from a wider spacing to a narrower spacing as one side end of the tubular wall 12 is wider than the opposite narrower side end thereof.

This embodiment also includes a sealing means 60 for sealing or substantially sealing the cold internal compartment of the cooler box 100. The sealing means 60 comprises a flexible member 62 having slits 64 formed therein which forms contiguous flaps extending across the cavity 29 of the wall 12 to substantially close the lower opening 18 but allow insertion of the caught fish therethrough. The flexible member 62 also seals against the caught fish. The flexible member 62 is held in place by a mounting ring 66 which is similarly shaped as the second flange 52. Edge portions of the flexible member 62 are sandwiched between the mounting ring 66 and the second flange 52. The bolts 54 extend through the second flange 52 and mounting ring 66 to hold the mounting ring 66 in place.

1. A fish handling stand for mounting to a lid of a cooler box, the cooler box having an aperture sized for a fish to extend therethrough and an inner cavity aligned with said aperture, the fish handling stand comprising:
a tubular wall having an upper edge defining an upper opening, a lower edge defining a lower opening, and an inner cavity;
a mounting means adjacent said lower edge so as to extend said tubular wall upwardly from said inner cavity of said cooler box lid; and
holding formations formed in said upper edge so as to seat a fish holding pin thereon.

2. The fish handling stand of claim 1, wherein the mounting means comprises flanges for attachment to the lid.

3. The fish handling stand of claim 1, wherein the holding formations comprises oppositely formed seats.

4. The fish handling stand of claim 3, wherein the seats are U-shaped cut-outs in the upper edge.

5. The fish handling stand of claim 1, wherein the tubular wall is circular or oval.

6. The fish handling stand of claim 1, wherein the stand comprises sealing means for the upper opening, or the lower opening, or the inner cavity.

7. The fish handling stand of claim 6, wherein the sealing means comprises bristles or flaps extending across the inner cavity.

8. The fish handling stand of claim 6, wherein the sealing means comprises a flexible member having slits formed therein which forms contiguous flaps extending across the inner cavity of the wall to substantially close the lower opening.

9. The fish handling stand of claim 6, wherein the sealing means is against the fish in the inner cavity in use.

10. The fish handling stand of claim 6, wherein the upper opening or the lower opening can be made resilient to be normally closed which can then be opened in use.

11. The fish handling stand of claim 1, wherein the stand comprises a retaining means for the fish holding pin thereon.

12. The fish handling stand of claim 1, wherein the stand comprises a fish holding pin for insertion into a fish gill cavity.

13. An assembly, comprising:
a lid for a cooler box; and
a fish handling stand of claim 1 mounted on said lid.

14. An assembly, comprising:
a cooler box having a lid; and
a fish handling stand of claim 1 mounted to the lid.

15. A method of handling fish, the method comprising the steps of:
forming an assembly, according to claim 14;
guiding the fish into the upper opening such that the fish is within the inner cavity;
inserting a fish holding pin through the gill cavity of the fish; and
placing the pin holder onto the holding formations of the upper edge.

16. The method of claim 15, further comprising the steps of:
removing the fish hook;
severing the gills of the fish with fin snips; and
pulling the fish holding pin to allow the fish to drop into the cooler box.
